(19) United States
(12) Patent Application Publication
(10) Pub. No.: US 2012/0061899 A1
(43) Pub. Date: Mar. 15, 2012

(54) TAIL RAIL - UNIVERSAL TAILGATE TOOL AND MATERIAL MOUNTING SYSTEM

(76) Inventor: Randy Leon Trombly, Plattsburgh, NY (US)

(21) Appl. No.: 12/879,437

(22) Filed: Sep. 10, 2010

(51) Int. Cl. B25B 11/00

(52) U.S. Cl. 269/309

(57) ABSTRACT

The Tail Rail is a Universal Tool and Material Mounting System that utilizes the Tail Gate of any Pick-up Truck as a Portable Work Bench. The Tail Rail features T-slotted bars that are affixed to the inside of the tail gate (using existing fasteners on the tail gate) and enables the mounting of several components such as vises, clamps, saws or any other device that may be used to hold any material or item. The invention features retractable outriggers that enable the device to support materials up to twelve feet in length. When the outriggers are retracted, the tailgate can be closed with the device remaining attached to the tailgate.

The Tail Rail is a Universal Tool and Material Mounting System that utilizes the Tail Gate of any Pick-up Truck as a Portable Work Bench. The Tail Rail features T-slotted bars that enable the mounting of several components such as vises, clamps, saws or any other device that may be used to hold any material or item.

### BACKGROUND OF INVENTION

Due to the recent downturn in the economy, and particularly the housing market, many homeowners are opting to stay in their homes longer and are investing in remodeling/upgrades to their existing homes. The ‘Handy Man’ market has exploded with many displaced workers getting into the remodeling business. Many of these ‘Handy Men’ work on small projects for short periods of time (often several at the same time) and need to be able to move efficiently between job sites. Most, if not all, of these individuals utilize pick-up trucks as their primary means of transporting materials and tools between job sites. The current invention will enable them to tear down and set-up their work area in a more time efficient manner.

Presently there are several devices that perform a similar task, however, all of these devices have integrated legs and are dedicated to one specific type of tool, ie, power miter saw. The current invention offers improved deployment and can universally accept different types of tools and material holders.

In addition to the Handy Man market, the current invention may also be utilized in the recreation segment. As an example, a ski vice can be mounted on the device to enable the user to apply wax or do other maintenance on their skis.

Additionally, the main body of the invention can be removed from the Tailgate and mounted on an optional leg attachment or mounted to an ATV's rack system.

### BRIEF SUMMARY OF INVENTION

The Tail Rail is a Universal Tool and Material Mounting System that utilizes the Tail Gate of any Pick-up Truck as a Portable Work Bench. The Tail Rail features T-slotted bars that enable the mounting of several components such as vises, clamps, saws or any other device that may be used to hold any material or item.

The Tail Rail is permanently mounted to the inside of the Pick-up Truck Tail Gate and has retractable Out Riggers that may be used to hold long materials such as dimensional lumber, pipes or other long items. All major components are manufactured of extruded aluminum and feature continuous t-slots (on all four sides) that enable infinite positioning of attachments. The Tail Rail is constructed completely of non-corrosive materials (aluminum, stainless steel and plastic) so that it can remain in the vehicle, exposed to the elements.

The Tail Rail attaches to any Pick-up Truck Tailgate utilizing the existing bolts/screws on the inside of the Tailgate. The mounting brackets are infinitely adjustable along the main axis of the Rail, enabling the brackets to be located in the proper position, regardless of vehicle make or model.

BRIEF DESCRIPTION OF THE SEVERAL VIEWS OF THE DRAWING

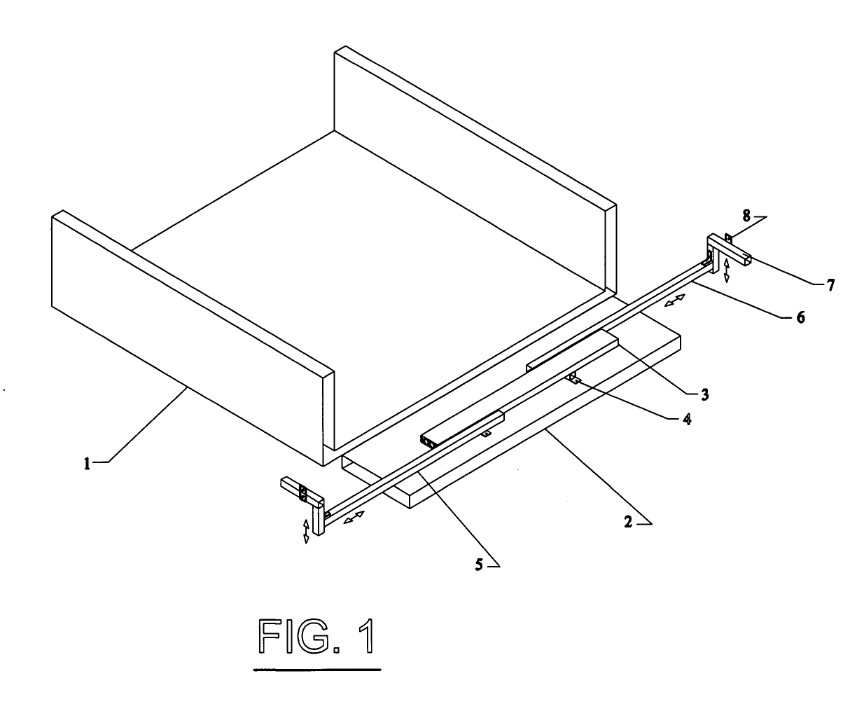

FIG. 1 is a perspective drawing of the invention with no attachments and the Outriggers in the extended position.

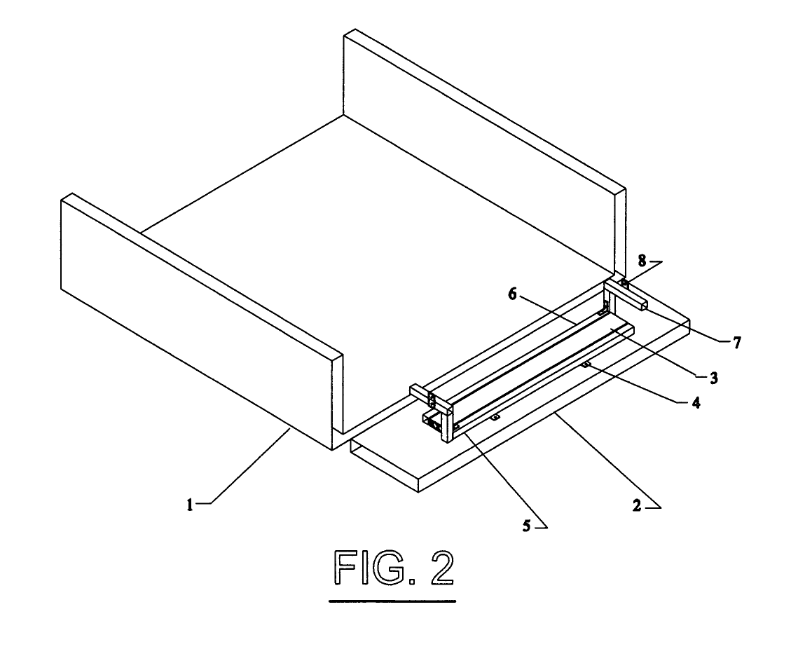

FIG. 2 is a perspective drawing of the invention with no attachments and the Outriggers in the retracted position.

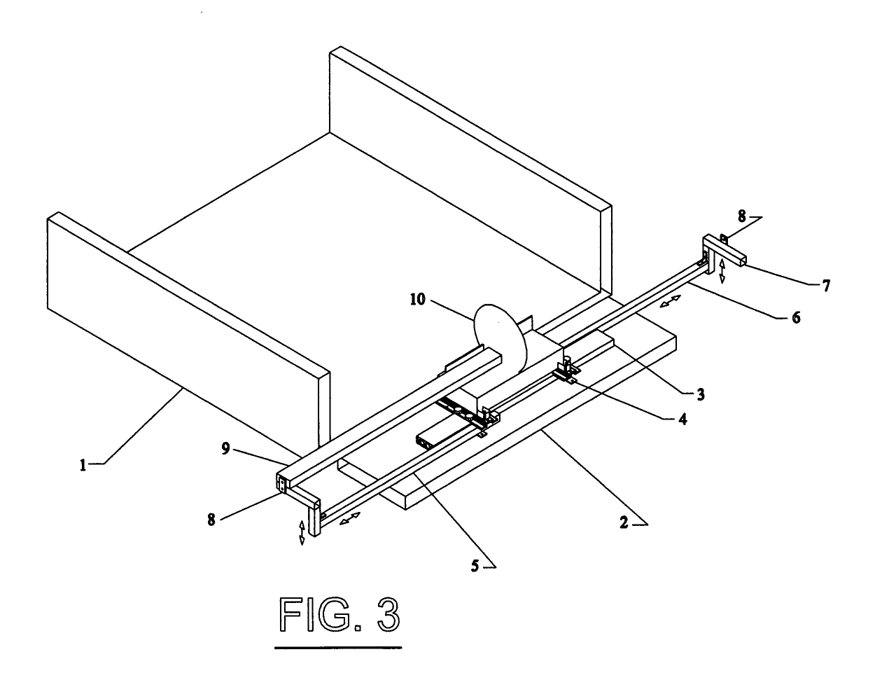

FIG. 3 is a perspective drawing of the invention with the Outriggers extended and a Miter/Chop Saw attachment.

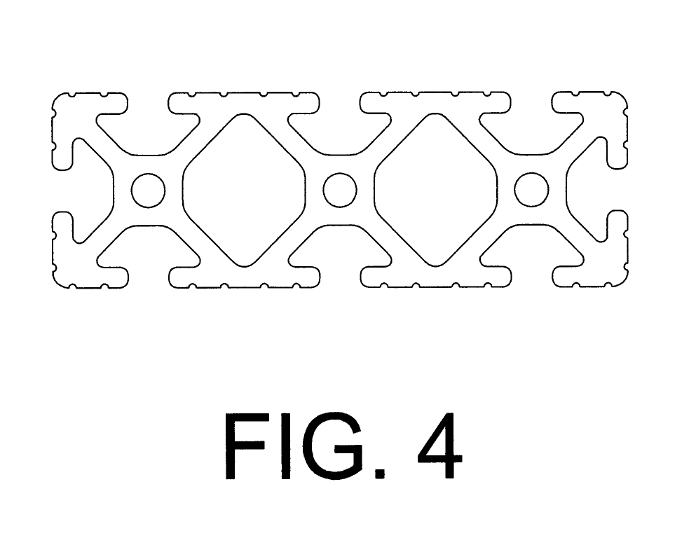

FIG. 4 is a cross sectional view of the invention's Main Rail, which shows the t-slot profiles.

### DETAILED DESCRIPTION OF THE INVENTION

Referring specifically to FIG. 1, where as the unit's Base Rail 3 is mounted to a Pick-up Truck Tailgate 2 via Mounting Brackets 4 which are infinitely adjustable along the long axis of the Base Rail 3 as to accommodate the mounting to any standard Pick-up Truck Tailgate 2.

The invention is unique in that it can accommodate the attachment of almost any device that requires a stable platform. All attachments are mounted in any of five (5) t-slots, three on the top surface and one on each of the side surfaces FIG. 4.

The invention features optional retractable Outriggers 5,6 that extend beyond the width of the Tailgate 2 and provide support to longer items such as dimensional lumber and piping. The Outriggers 5,6 can be fully retracted to enable the Tailgate 2 to be closed as normal. The Outriggers 5,6 are manually slid into position and locked with a hand knob. The invention also features Vertical Supports 7 that enable adjustment in the vertical plane in order to facilitate the positioning of the material at the same level as the base of the power tool or vise.

As in FIG. 2, the invention features Material Stops 8 that may be used to establish a repeatable length for cutting applications such as in the case of a Miter Saw 10 and dimensional lumber 9. The Material Stop 8 is adjustable along a plane perpendicular to the cutting plane and can be retracted when not in use.

1. A Universal Tool and Material Mounting Device is attached to the Tailgate of a Pick-up Truck.

2. The device according to claim 1, is mounted using infinitely adjustable brackets enabling its use in most all Pick-up Trucks.

3. The device according to claim 1, is designed with endless t-slots on all four sides, enabling infinite positioning of attachments.

4. The device according to claim 1, is made of entirely weather resistant materials (aluminum, stainless steel and plastic) so as to be corrosion resistant and able to remain in the elements.

5. The device according to claim 1, has integrated, retractable Outriggers which enable the device to support longer material items, such as lumber or piping.

6. The device according to claim 5, has retractable Outriggers that allows the Tailgate to operate (open and close) as normal when the Outriggers are in the retracted position.

7. The device according to claim 5, has vertically adjustable material supports which enable the device to support materials in a level plane with a power tool's or vise's base.

8. The device according to claim 5, has retractable material stops to enable the operator to make multiple cuts at a repeatable length.
